(19) United States
(12) Patent Application Publication
(10) Pub. No.: US 2017/0282341 A1
(43) Pub. Date: Oct. 5, 2017

(54) DRIVER DEVICE HAVING A GAS SPRING

(71) Applicant: HILTI AKTIENGESELLSCHAFT, Schaan (LI)

(72) Inventors: Iwan WOLF, Untervaz (CH); Karl FRANZ, Oppenweiler (DE); Mario GRAZIOLI, Chur (CH)

(73) Assignee: HILTI AKTIENGESELLSCHAFT, Schaan (LI)

(21) Appl. No.: 15/511,359

(22) PCT Filed: Sep. 22, 2015
(86) PCT No.: PCT/EP2015/071693

§ 371 Date: Mar. 15, 2017

(30) Foreign Application Priority Data
Sep. 25, 2014 (EP) 14186424.9

(51) Int. Cl. B25C 1/04; B25C 1/06

(52) U.S. Cl. CPC B25C 1/047; B25C 1/06

(57) ABSTRACT

The invention relates to a driver device, comprising a rotating motor, a gas spring having an elastically compressible gas volume, and a setting piston, wherein the gas spring can be loaded by the motor by means of a loading mechanism in order to accelerate the setting piston in a driving direction after a release from the loaded state, wherein the gas spring comprises a piston head guided in a gas-tight manner, which is adjoined by a piston rod as a separate component in the driving direction, wherein the piston rod is connected to the piston head by means of a thrust bearing that can be pivoted in several planes.

The invention relates to a driver device, in particular a hand-held driver device, in accordance with the pre-characterizing clause of claim 1.

WO 2009/046076 A1 describes a driver device for driving a nail into a workpiece, in which a gas spring is pre-loaded by an electric motor in order to drive home a setting piston. A piston member of the gas spring is connected via a hinged joint to a substantially strip-shaped piston rod such that angular compensation between piston member and piston rod can only occur in one plane. In addition, the load on the hinged joint in the region of a hinge pin means a limitation on the transmittable forces and therefore the driving energy.

It is the object of the invention to specify a driver device which enables a high driving energy.

According to the invention, this object is achieved for a driver device mentioned in the introduction by the characterizing features of claim 1. By providing a thrust bearing that can be pivoted in several planes, the piston rod can deviate with respect to the piston head in an optimum manner, so that as few moments as possible act on the piston head.

This enables optimum and long-term sealing of the piston head so that gas springs in particular can be used with high pre-loading or permanently high application of pressure.

The piston head is usually guided in a cylinder. As a rule, the piston rod has a considerably smaller diameter than the piston head. Within the meaning of the invention, it can act as a setting piston in that a nail-side end of the piston rod is formed accordingly. However, depending on the requirements, the setting piston can also be designed as a component which can move separately from the piston rod or as a component which is separate but securely connected to the piston rod.

Within the meaning of the invention, the thrust bearing absorbs forces acting in the driving direction and transmits them to the piston rod. Forces in other directions do not necessarily have to be capable of being transmitted by the thrust bearing.

For the optimum transmission of larger forces, the thrust bearing preferably comprises a pair of press surfaces which are in each case rotationally symmetrical about a central axis of the piston head. Here, the one press surface is expediently formed on the piston head and the other press surface is formed on the piston rod.

In a first possible embodiment, the press surfaces have different radii of curvature in their region of contact. As a result, the pivoting of the thrust bearing to compensate for misalignments is particularly smooth. Preferably, one of the press surfaces, in particular the press surface of the piston rod, is formed in a convex manner. The other press surface can accordingly be formed in a concave manner with a larger radius of curvature, or also flat.

In an alternative embodiment, the press surfaces have the same radii of curvature in their region of contact. This can be the case, for example, when the thrust bearing is designed as a ball joint. With such an embodiment, the press surfaces contact one another to a particularly great extent with correspondingly good transmission of force. Such an embodiment also includes flat press surfaces, wherein an appropriate compensation of a misalignment is achieved by elastic deformation of appropriately chosen materials for piston head and/or piston rod.

In a particularly preferred embodiment, at least one of the press surfaces is formed on an insert part which is fixed to one of the two, piston head or piston rod. Thus the insert part, for example, can be made from a particularly hard material, such as steel for example, and the forces which occur can be transmitted via a relatively small surface contact. The rest of the component, in particular the piston head, can be made from a softer material, such as plastic or aluminum for example. Generally advantageously, the piston head can be made from a material with a density of less than 3.5 g/cm³, and the piston rod can be made from a material with a density of more than 3.5 g/cm³.

In a generally advantageous embodiment, the piston rod is made from a metal, in particular a steel. This enables larger impulses to be absorbed and higher energies to be transmitted to the nail member. The piston head can be made from a softer material such as plastic or a lightweight metal.

In a preferred detail design, a radially inward facing, in particular curved, edge, by means of which the piston rod is guided in a radial direction by the piston head, is formed on the piston head. Such guidance of the piston rod is long-lasting and interacts in a simple way with the thrust bearing. At the same time, a lead-in bevel can be provided, by means of which the piston rod is centered on an axis of the piston head.

Basically, it can be provided that the piston rod is not connected to the piston head in the driving direction. This enables the piston rod to freely lead or lift off in the driving direction, as a result of which the piston head is particularly protected, for example in the case of operations carried out when empty.

In a generally preferred driving device, a structure part of non-uniform material, by means of which the piston rod can be coupled to the electric motor, is fixed to the piston rod. The separate formation of the structure part enables a simple, for example rotationally symmetrical, shape of the piston rod, which is advantageous, particularly in the case of high material densities and material hardnesses of the piston rod. Particularly preferably, the structure part is molded onto the piston rod as a cast part. For example, the piston rod can be made from a steel or other high-strength metal, wherein the structure part is molded onto the piston rod as a plastic cast part or also as a lightweight-metal cast part.

In a preferred embodiment of the invention, the piston rod includes a ball head as part of the thrust bearing. This enables a particularly large transmission of force.

In a further preferred embodiment, the piston rod is connected to the piston head by means of an elastic snap connection. This enables the piston rod to be easily pivoted about small angles due to the elasticity of the snap connection.

In a further preferred embodiment, the piston rod is connected to the piston head by means of a pliable plastic. Such a plastic can, for example, be injection-molded on in order to achieve a long-lasting, interlocking connection of the piston rod to the piston head. The elasticity of the plastic allows adequate pivoting of the piston rod in several planes. The plastic can preferably be a thermoplastic elastomer (TPE) of appropriately optimized hardness.

In general, a driver device according to the invention is preferably designed for high driving energies. Here, the drive energies can exceed values of 30 Joules, preferably 40 Joules.

Further advantages and characteristics of the invention can be seen from the exemplary embodiments described below and the dependent claims.

Several exemplary embodiments of the invention are described below and explained in more detail with reference to the attached drawings.

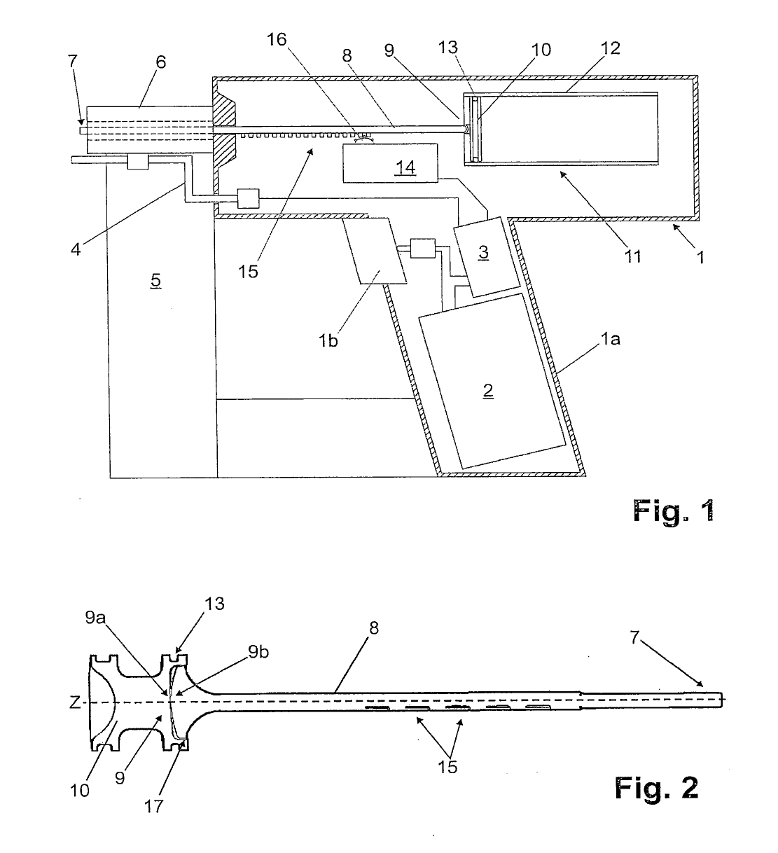

FIG. 1 shows a schematic overall view of a driver device according to the invention.

FIG. 2 shows a sectional view of a piston head and a piston rod according to a first exemplary embodiment of the invention.

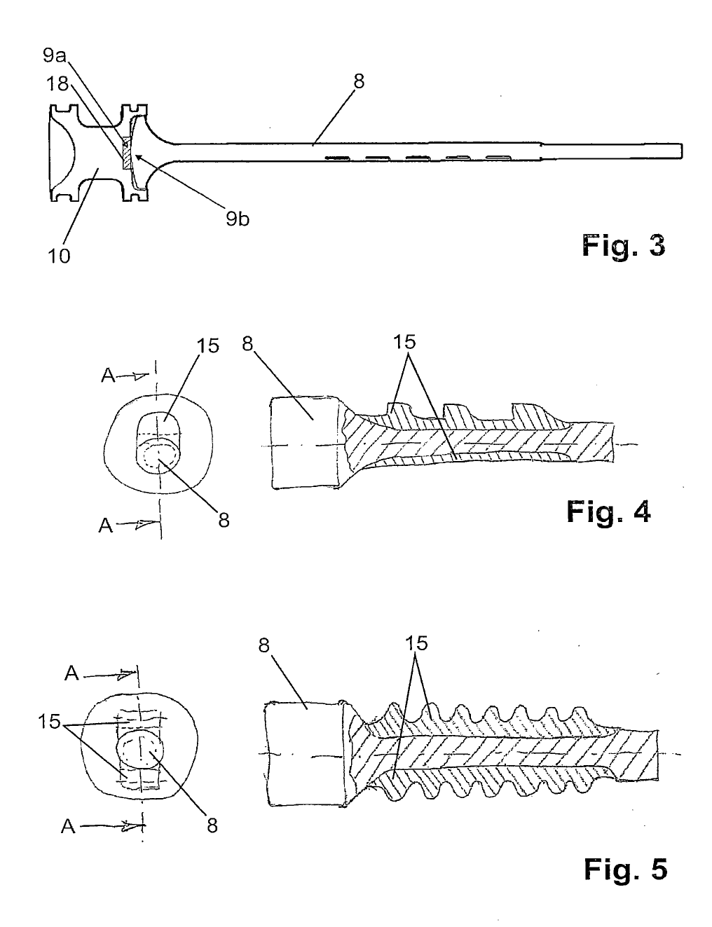

FIG. 3 shows a preferred development of the exemplary embodiment from FIG. 2.

FIG. 4 shows a schematic plan view and sectional view along the line A-A of a piston rod of a further exemplary embodiment of the invention.

FIG. 5 shows a preferred development of the piston rod from FIG. 4.

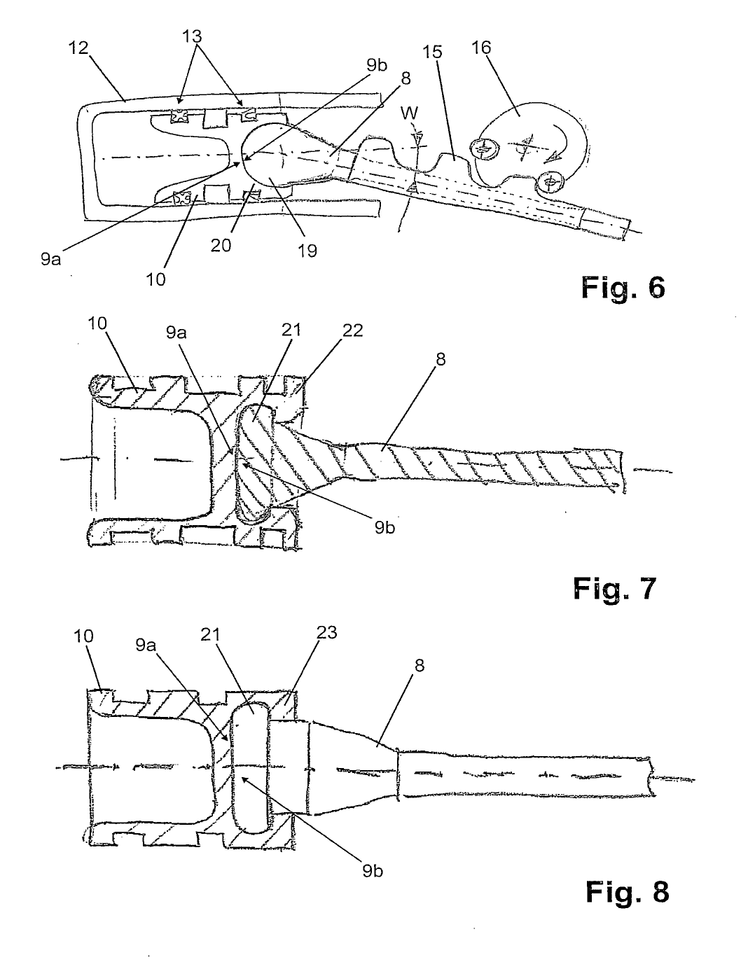

FIG. 6 shows a further exemplary embodiment of the invention with a ball joint as thrust bearing.

FIG. 7 shows a further exemplary embodiment of the invention with a mounting of the piston rod in the form of a clip.

FIG. 8 shows a further exemplary embodiment of the invention with a mounting of the piston rod in the form of an elastic overmolding.

According to FIG. 1, a driver device according to the invention is mounted in a hand-held housing 1. The housing 1 has a handle 1a with a trigger 1b for initiating a driving operation. An accumulator 2 for storing electrical energy, a control electronics unit 3 and a safety sensor 4 for the safe release of a driving operation are provided in the housing 1.

One nail at a time is loaded from a nail magazine 5 into a muzzle 6 of the driver device. From this position, the nail is driven into a workpiece by the impact of a setting piston 7.

Here, the setting piston 7 is formed as the front end of a piston rod 8 in the driving direction. At its rear end, the piston rod 8 rests on a piston head 10 via a thrust bearing 9. As the moving part of a gas spring 11, the piston head 10 is guided in a cylinder 12 and is sealed in a pressure-tight manner by the circumferential seals 13.

Even in a maximally relaxed state (FIG. 1), the gas spring 11 is permanently filled with a gas under positive pressure in order to increase the energy absorption on each stroke or the spring constant.

The gas spring is loaded by moving the piston rod 8 by means of an electric motor 14 in the opposite direction to the driving direction. For this purpose, a structure 15 is formed on the piston rod 8, which meshes with a rotating drive member 16 of the electric motor 14, thus collectively forming a loading mechanism. The structure 15 has substantially the form and function of a toothed rack. Further parts of the loading mechanism can include a retaining member, for example, by means of which the loaded gas spring can be triggered (not shown).

The diagram according to FIG. 1 is purely schematic. Here, within the meaning of the invention, the combination of piston rod 8 and piston head 10 is formed in a particular way, wherein the thrust bearing 9 allows a small degree of pivoting of the piston rod 8 with respect to the piston head 10 in several planes. In particular, the pivoting can take place in any direction. Different solutions and detailed designs, which are explained in detail below, are proposed for this.

According to the example of FIG. 2, the thrust bearing 9 is formed by two press surfaces 9a, 9b, which are pressed against one another at least during an acceleration of the piston rod. Here, the press surfaces are formed rotationally symmetrically about a central axis Z extended in the driving direction.

The first press surface 9a is formed as a substantially flat surface (infinite radius of curvature) on a face of the piston head 10. In the example of FIG. 2, it is made from the material of the piston head, here a plastic.

The second press surface 9b is formed as a convex surface (positive radius of curvature) on a mushroom-shaped rear end of the piston rod 8. The press surfaces 9a, 9b therefore have different radii of curvature in their region of contact; purely geometrically, the surfaces therefore touch at only one point. The actual contact area of the press surfaces is, of course, larger, wherein the size depends on the hardness of the surface materials and on the magnitude of the contact force.

Here, the piston rod is made from a steel in order to be able to transmit larger setting energies of more than 40 Joules to the nail.

A radially inward facing outer edge 17 is stepped into the piston head, by means of which the rear, mushroom-shaped end of the piston rod 8 is guided in a radial direction at least while the press surfaces 9a, 9b are in contact. The edge 17 also has a chamfer, by means of which the piston rod 8 is guided in a self-centering manner in case the piston rod 8 disengages from the piston head 10 in the course of the driving operation.

In this respect, it is pointed out that, in the example of FIG. 2, there is no tensile connection between piston rod 8 and piston head 10, only a pressure-tight one. In this sense, the piston rod is not connected to the piston head in the driving direction.

FIG. 3 shows a development of the example from FIG. 2. Here, the only difference is that, on the piston head 10 side, the press surface 9a is formed on an insert part 18, which is set into the face of the piston head 10 and is made from a high-strength material such as steel, for example. This enables acceleration forces to be transmitted in a wear-free manner with low friction. The rest of the piston head 10 is made from a softer and lighter metal such as plastic or lightweight metal.

In the examples according to FIG. 2 and FIG. 3, the structure 15 is formed as a series of recesses which are made in the steel piston rod 8.

In the example shown in FIG. 4, the structure 15 has been injection-molded onto a steel core of the piston rod 8 as a plastic structure part. For this purpose, the piston rod 8 has a narrower section, by means of which the plastic of the structure part 15 is retained in an interlocking manner.

FIG. 5 shows a development of the example from FIG. 4, wherein the structure part 15 has teeth for intermeshing on at least two opposing sides. This enables a particularly large friction connection to be realized. In the example according to FIG. 4, the teeth are formed only on one side of the piston rod.

FIG. 6 shows a further exemplary embodiment of the invention. Here, the piston rod 8 is connected to the piston head 10 by means of a ball head 19. The convex ball head 19 engages in a corresponding ball socket 20 with the same radius of curvature in the piston head 10. Accordingly, the press surfaces 9a, 9b are particularly large. The ball joint can be closed or open depending on the circumferential angle of the ball socket 20. Accordingly, the piston rod can also be retained in the tensile direction by interlocking, or be freely movable away from the piston head in the tensile direction.

The piston rod 8 can be pivoted in any plane about an angle W with respect to the piston head 10. In FIG. 6, the angle W is shown disproportionately large. In practice, typical pivot angles for compensating for tolerances are usually less than 1 degree.

In the version shown according to FIG. 6, the structure 15 is also injection-molded onto the piston rod 8 in a similar way to FIG. 4.

The seal 13 of the piston head is shown in FIG. 6 as an assembly of three rings. A front ring in the driving direction is formed as a scraper ring, a central ring is formed as an oil-saturated felt ring, and a rear ring is formed as a pressure-tight seal.

The exemplary embodiment according to FIG. 7 shows a variant in which the piston rod 8 has a circumferential bead 21, which is retained in an interlocking manner in the driving direction by an elastic, circumferential latching ring 21. As a result, the piston rod is connected to the piston head 10 in the manner of a snap connection, thus enabling a force to be also transmitted in the tensile direction. Here, the press surfaces 9a, 9b are each flat, wherein a pivoting in all planes is achieved by the elasticity of the piston material or at least of the material of the snap ring 22.

FIG. 8 shows a similar example to FIG. 7, in which, instead of the snap ring, a front part of the piston head 10 is formed in one piece as ring 23 from a pliable plastic, here a thermoplastic elastomer. By this means, the piston rod 8 is permanently connected to the piston head in an interlocking manner, so that, here too, a force can be transmitted in the tensile direction. The ring 23 can be formed on the piston head 10 and piston rod 8 by an injection-molding technique for example. Here, the pivoting of the piston rod 8 in all planes is provided mainly by the elasticity of the ring 23.

It is understood that at least one of the press surfaces 9a, 9b of the examples from FIG. 7 and FIG. 8 can have a convex curvature.

In general, the specific characteristics of the different exemplary embodiments can be combined with one another depending on requirements. In particular, the recesses of the structure part 15 according to FIG. 4 and FIG. 5 can be present in all exemplary embodiments.

1. A driver device, comprising
a rotating motor
a gas spring having an elastically compressible gas volume, and
a setting piston, and a loading mechanism,
wherein the gas spring can be loaded by the rotating motor by the loading mechanism in order to accelerate the setting piston in a driving direction after a release from a loaded state,
wherein the gas spring comprises a piston head guided by gas, wherein the gas spring is adjoined by a piston rod
and wherein
the piston rod contacts the piston head by a thrust bearing that can be pivoted in several planes.

2. The driver device according to claim 1, wherein the piston head has a central axis (Z), and the thrust bearing comprises a pair of press surfaces which are each rotationally symmetrical about the central axis (Z) of the piston head.

3. The driver device according to claim 2, wherein each of the press surfaces has a region of contact for the piston head, the region of contact having a radius of curvature, wherein one radius of curvature is different than another radius of curvature.

4. The driver device according to claim 2, each of the press surfaces has a region of contact for the piston head, the region of contact having a radius of curvature, wherein one radius of curvature is the same as another radius of curvature.

5. The driver device according to claim 2, wherein at least one of the press surfaces is an insert part fixed to the piston head or to the piston rod.

6. The driver device according claim 1, wherein the piston rod is made from a metal.

7. The driver device according to claim 1, wherein the piston head comprises a radially inward facing edge for guiding the piston rod in a radial direction by the piston head.

8. The driver device according claim 1, wherein the piston rod is not connected to the piston head in the driving direction.

9. The driving device according to claim 1, wherein the loading mechanism comprises a structure part of non-uniform material, for coupling the piston rod to the rotating motor.

10. The driving device according to claim 9, wherein the structure part is molded onto the piston rod.

11. The driver device according to claim 1, wherein the piston rod has a ball head as part of the thrust bearing.

12. The driver device according to claim 1, wherein the piston rod is connected to the piston head by an elastic snap connection.

13. The driver device according to one claim 1, wherein the piston rod is connected to the piston head by a pliable plastic.

14. The driver device of claim 1, wherein the rotating motor is an electric motor.

15. The driver device according to claim 3, wherein at least one of the press surfaces is an insert part fixed to the piston head or to the piston rod.

16. The driver device according to claim 4, wherein at least one of the press surfaces is an insert part fixed to the piston head or to the piston rod.

17. The driver device of claim 6, wherein the metal is steel.

18. The driver device of claim 7, wherein the edge is curved.

19. The driver device according to claim 2, wherein the piston head comprises a radially inward facing edge for guiding the piston rod in a radial direction by the piston head.

20. The driver device according to claim 3, wherein the piston head comprises a radially inward facing edge for guiding the piston rod in a radial direction by the piston head.
